(19) United States
(12) Patent Application Publication
(10) Pub. No.: US 2013/0258436 A1
(43) Pub. Date: Oct. 3, 2013

(54) PATTERNED OBSCURATION LINES FOR ELECTROCHROMIC DEVICES

(71) Applicant: SAGE Electrochromics, Inc., Faribault, MN (US)

(72) Inventors: Louis J. Podbelski, Eagan, MN (US); Ole Buesing, Faribault, MN (US); Jean-Philippe Savary, Northfield, MN (US)

(73) Assignee: SAGE ELECTROCHROMICS, INC., Faribault, MN (US)

(21) Appl. No.: 13/797,610

(22) Filed: Mar. 12, 2013

Related U.S. Application Data
(60) Provisional application No. 61/619,719, filed on Apr. 3, 2012.

(51) Int. Cl. G02F 1/157; G02B 1/10

(52) U.S. Cl. CPC G02F 1/157; G02B 1/10
USPC 359/265; 359/893

(57) ABSTRACT

An electrochromic device is provided. The device may be inserted within a frame. The device may include a substrate, an electrochromic coating, and a patterned layer. The electrochromic coating may overlie a portion of the substrate within a visible region of the substrate. The electrochromic coating may have an outer edge that is spaced from an outer boundary of the visible region of the substrate. The outer edge of the electrochromic coating and the outer boundary of the visible region may define a working region. The patterned layer may be deposited within the working region. The patterned layer may include a plurality of spaced apart shapes.

### CROSS-REFERENCE TO RELATED APPLICATIONS

The present application claims the benefit of the filing date of U.S. Provisional Patent Application No. 61/619,719 filed Apr. 3, 2012, the disclosure of which is hereby incorporated herein by reference.

### FIELD OF THE INVENTION

This invention relates to switchable or active technology glazing devices, and in particular, relates to the obscuration of such devices.

### BACKGROUND OF THE INVENTION

Insulated glass units (IGUs) include opposing glass lite panels separated by a spacer along the edge in which the spacer and the glass sheets create a seal around a dead air space (or other gas, e.g., argon, nitrogen, krypton). A series of thin films, known as electrochromic glazings, are applied or deposited to one of the glass lite panels. Electrochromic glazings or coatings include electrochromic materials that are known to change their optical properties in response to the application of an electric potential which can create coloration or tinting within the electrochromic glazings. Common uses for these glazings include architectural windows, as well as windshields and mirrors of automobiles. Further details regarding the formation of IGUs can be found in, for example, U.S. Pat. No. 7,372,610; U.S. Pat. No. 7,593,154; and U.S. Pat. Appl. Publ. No. 2011/0261429 A1, the entire disclosures of which are hereby incorporated by reference herein.

Current IGUs often have printed busbars and have non-active or non-coloring areas near edges of visible viewing regions within such IGUs that are generally perceived to be aesthetically undesirable features. Obscuration has been used to mask these undesirable features. Current edge obscuration however utilizes a straight solid line, i.e., “hard edge,” that cannot sufficiently disguise conspicuous or recognized misalignment. Precise alignment of the IGUs by a contractor, such as a glazing contractor, working on the installation or repair of IGUs may be difficult and expensive.

Thus, there exists a need for obscuration that disguises recognized misalignment without incurring such labor-intensive costs.

### SUMMARY OF THE INVENTION

As used herein, the terms “width” and “length” refer to directions parallel to surfaces of a substrate. The term “thickness” is used to refer to a dimension measured in a direction perpendicular to the surfaces of such a substrate.

To lessen the visual or actual impact of these often undesirable features, at least one side of an electrochromic device, such as an edge thereof, may include one or more obscuration patterns. An obscuration pattern desirably may be designed to disguise undesirable features along the visible edges of an electrochromic device and have a minimum width necessary to perform this function in order to maximize the unobstructed viewing area through an electrochromic device and to add the least amount of cost to the production of such devices.

In some arrangements, an obscuration pattern may be printed. In some arrangements, the pattern may be formed using screen-printing of inorganic or organic inks, such as but not limited to an ink based on reactive acrylates, that bond to a substrate, such as but not limited to glass, after a heat treatment, such as but not limited to curing by ultraviolet light or other known curing methods. In some arrangements, the reactive acrylates preferably may be dark or pigmented, which may act to obscure a view of undesirable features. In some arrangements, an obscuration pattern is prepared by digital printing of organic inks, inorganic inks, or mixtures thereof. Such digital printing may be used to automatically and accurately print patterns, which may have any color, onto the substrate. In some arrangements, a pattern in accordance with the present invention may be formed onto glass, for example tempered glass used for vehicle windshields. In some arrangements, a screen-printed pattern may be printed on any of a series of attachable substrates such as but not limited to float glass, electrochromic glass, or a thin film material. In such arrangements, the pattern on each of these individual substrates may have approximately the same dimensions, each having approximately the same pattern.

In some arrangements, a pattern may be applied using adhesive tape, which may be used to apply an obscuration band, an obscuration band being an opaque area in the glass, as used herein. In some such arrangements, straight lines or for shapes, such as but not limited to circular, rectangular, or triangular dots that may be formed on the adhesive tape, which may then be applied directly to a substrate.

In some arrangements, the obscuration pattern may be applied to two sides, which may be two edges, of an electrochromic device. In some arrangements, the obscuration pattern may be applied to three sides, which may be three edges, of an electrochromic device. In some arrangements, the obscuration pattern may be applied to four sides, which may be four edges, of an electrochromic device. In some arrangements, the obscuration pattern may be predetermined over at least a portion of the electrochromic device. In some arrangements, the pattern may be repeating in a direction parallel to a given side of an electrochromic device. In some arrangements, the pattern may be repeating in a direction perpendicular to a given side of an electrochromic device.

In some arrangements, an obscuration pattern may be formed from a single layer or coating of repeating shapes. In other arrangements, a final pattern may be the result of forming multiple overlapping shapes or patterns, which may be formed from single or multiple coatings. In other arrangements, single layers of single layer or multiple layer patterns or even separate layers of a multiple layer pattern may include the same or different colors. In some arrangements, the pattern may include a sequence of dots of the same size. In other embodiments, the pattern may include dots of varying sizes. In other embodiments, the dots may have different sizes in which radii of a sequence of the dots decrease in a direction away from an initial solid pattern. In some arrangements, the pattern may include a series of lines having either or both of various thicknesses and opacities. In some such arrangements, the series of lines may be parallel while in other such arrangements, the series of lines may be skewed or even perpendicular to other lines of the series of lines.

In some arrangements, the obscuration pattern may be placed onto other fixtures or coatings or other layers already on a substrate such as but not limited to a reflective coating, a solar control coating, or a photocatalytic layer coating that may make cleaning of a substrate easier.

In accordance with an embodiment of the invention, an electrochromic device may be provided that includes a substrate, an electrochromic coating, and at least one patterned layer. The electrochromic coating may overlie a portion of the substrate within a visible region of the substrate. The electrochromic coating may have an outer edge spaced from an outer boundary of the visible region of the substrate. The outer edge of the electrochromic coating and the outer boundary of the visible region may define a working region. The patterned layer may be deposited within the working region. The patterned layer may include a plurality of spaced apart shapes.

In some arrangements, the electrochromic device may be inserted within a frame. The shapes may run parallel to at least one of (i) the outer edge of the electrochromic coating, an inner edge of a seal between the device and the frame, and (iii) and an inner rim of the frame. In some arrangements, the shapes may be lines. In some such arrangements, the shapes may be parallel. In some arrangements, the shapes may be dots.

In some arrangements, the dots may include at least a first plurality of dots arranged along a first line and a second plurality of dots arranged along a second line. In some such arrangements, the first plurality of dots may be parallel to the second plurality of dots. In some arrangements, each dot of the first plurality of dots may have a first size and each dot of the second plurality of dots may have a second size in which the first size is different than the second size. In some arrangements, the dots may include at least a third plurality of dots arranged along a third line. In some such arrangements, the third plurality of dots may be parallel to the first and second pluralities of dots. In some such arrangements, each dot of the first, second, and third pluralities of dots may have first, second, and third radii, respectively. In some such arrangements, the second pluralities of dots may be between the first and third pluralities of dots. In some such arrangements, the first radii of the first plurality of dots may be greater than the second radii of the second plurality of dots. In some such arrangements, the second radii of the second plurality of dots may be greater than the third radii of the third plurality of dots.

In some arrangements, at least some of the shapes may have at least one of different widths and different thicknesses. In some arrangements, the device may be inserted within a frame. In some arrangements, the visible region may be defined by one of an inner edge of a seal between the device and the frame and an inner rim of the frame. In some arrangements, some of the spaced apart shapes may have a different shape than other ones of the spaced apart shapes. In some such arrangements, the shapes may include any of circles, triangles, and rectangles. In some arrangements, the patterned layer may have a thickness in the range between about 1 micrometers and 50 micrometers.

In some arrangements, the substrate may include at least one of a reflective coating, a solar control coating, and a photocatalytic coating. In some such arrangements, the patterned layer may be deposited onto any one or more of these coatings. In some arrangements, the substrate may have four sides. In some such arrangements, the patterned layer may be applied to one of (i) only one side, (ii) only two sides, (iii) only three sides, and (iv) all four sides of the substrate. In some arrangements, at least a portion of the patterned layer may be formed of a plurality of overlapping layers. In some arrangements, at least one layer of the plurality of overlapping layers may have a different color than another of the plurality of overlapping layers. In some arrangements, at least one of the spaced apart shapes may have a different color than another one of the spaced apart shapes. In some arrangements, the patterned layer may be deposited onto the outer edge of the electrochromic coating. In some arrangements, the patterned layer may be deposited onto the substrate such that it overlaps a projection on the substrate of the outer edge of the electrochromic coating within said visible region.

In accordance with another embodiment, an electrochromic device including a substrate, an electrochromic coating, and at least one patterned layer. The electrochromic device may be inserted within a frame. The electrochromic coating may cover a portion of the substrate within a visible region of the substrate. The visible region may be defined by one of an inner edge of a seal and an inner rim of the frame. The electrochromic coating may have an outer edge spaced from an outer boundary of the visible region of the substrate. The outer edge of the electrochromic coating and the outer boundary of the visible region may define a working region. The patterned layer may be deposited within the working region. The patterned layer may include at least one of (i) a plurality of lines spaced apart from each other and (ii) a plurality of dots spaced from one another.

In accordance with another embodiment, a substrate may include a stack of thin films having at least one edge. The substrate may further include at least one patterned layer deposited on top of the thin film edge. The patterned layer may run approximately the length of the edge. The patterned layer may include at least one of (i) a series of lines and (ii) a series of dots.

In some arrangements, the stack of thin films may include at least one electrochromic material. In some arrangements, the electrochromic material may comprise a mixed tungsten-nickel oxide. In some arrangements, the electrochromic material may be a tungsten oxide.

### BRIEF DESCRIPTION OF THE DRAWINGS

FIG. 1 is a cross-sectional elevation view of a portion of an electrochromic device installed within a frame in accordance with an embodiment of the invention.

FIGS. 2(A)-(C) are plan views of examples of different obscuration patterns in accordance with various arrangements of the invention.

FIGS. 3(A)-(B) are plan views of examples showing the edge of the glass, an unprinted band, the printed band, and the visible region.

FIG. 4 is a process flow diagram of an arrangement for fabricating an electrochromic device with an obscuration pattern in accordance with an embodiment of the invention.

### DETAILED DESCRIPTION

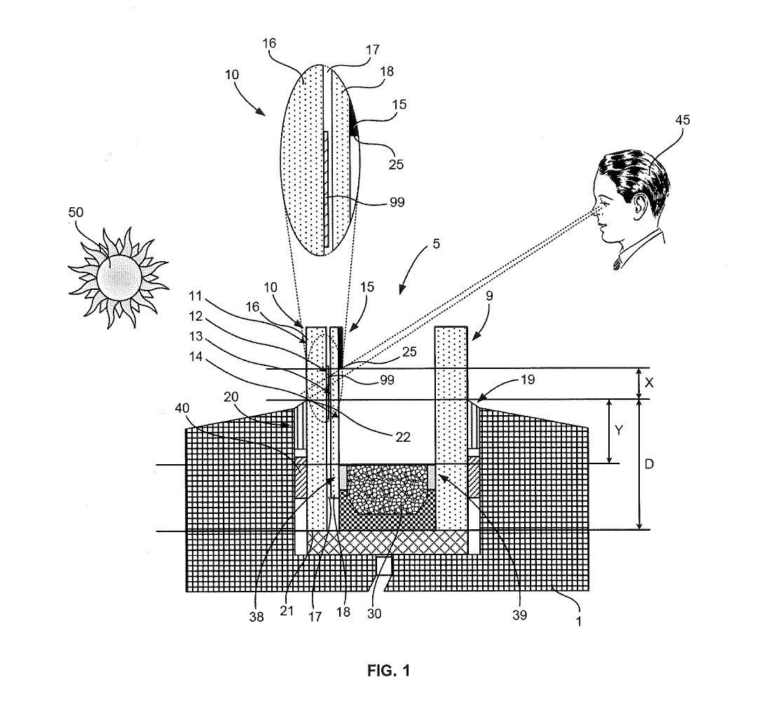

Referring to FIG. 1, in accordance with an embodiment, an electrochromic device may be an insulated glass unit (IGU) 5 having an inboard glass lite 9 and an outboard glass lite 10. As shown, the inboard glass lite 9 may be made clear float glass. As further shown, the outboard glass lite 10 may include an outer ply layer 16 between and defined by an exterior surface 11 and an interior surface 12, which may be made of clear float glass. The outboard glass lite 10 may include an inner ply layer 18 between and defined by an inner surface 13 and an inside surface 14. In some arrangements, the inner ply layer 18 may include a clear float glass. As shown in FIG. 1, the inside surface 14 of the inner ply layer 18 may be coated with an electrochromic coating 15, which may be various oxide thin films known to those of ordinary skill. The outboard glass lite 10 may include an interlayer 17 between the outer ply layer 16 and the inner ply layer 18, which may be a clear layer. Electrochromic coatings are composed of stacks of thin-films and are, for example, disclosed in U.S. Pat. Nos. 7,372,610 and 7,593,154, the disclosures of which are hereby incorporated by reference herein. Of course, the electrochromic coatings are not limited to those disclosed above and may include other types of coatings, such as but not limited to thermochromic coatings.

As further illustrated in FIG. 1, in some arrangements, the IGU 5 may include a spacer 30 which may be inserted between outer and inner spacer seals 38, 39, respectively. The outer and inner spacer seals 38, 39 in turn may be inserted between, and may be sealingly engaged with, the spacer 30 and the inside surface 14 and the spacer 30 and an interiorly facing surface of the inboard glass lite 9, respectively. In some arrangements, the spacer 30 and the outer and inner spacer seals 38, 39 may circumscribe a perimeter (not shown) of the IGU 5 between the inboard glass lite 9 and the outboard glass lite 10. In this manner, the spacer 30 and the outer and inner spacer seals 38, 39 may surround a visible region 90 as discussed further herein.

Exterior to the IGU 5 may be an architectural building frame 1. Inner frame seal 19 may be inserted between, and may be sealingly engaged with, the frame 1 and the exterior surface 11 and outer frame seal 20 may be inserted between, and may be sealingly engaged with, the frame 1 and an exteriorly facing surface of the inboard glass lite 9. In some arrangements, the frame 1 and the inner and outer frame seals 19, 20 may circumscribe inner and outer perimeters (not shown) of the IGU 5 interior to and exterior to the IGU 5, respectively. In this manner, either or both of the frame 1 and the inner and outer frame seals 19, 20 may surround, and further may define, at least a portion of the visible region 90, as discussed further herein.

Still referring to FIG. 1, in some arrangements, an outer edge 25 of the electrochromic coating 15 may be formed along the inside surface 14 at a distance D+x from an edge 21 of the outboard glass lite 10. In such arrangements, as shown, the distance D may be a distance from the edge 21 to a line through an inner tip 22 of the outer frame seal 20 perpendicular to the inside surface 14. In the example shown, the distance x may be a distance from the line through the inner tip 22 of the outer frame seal 20 perpendicular to the inside surface 14 to the outer edge 25 of the electrochromic coating 15. Such a distance is representative of what is typically considered to be the visible region of the IGU 5 through which a person 45 will view the environment 50 which is not coated with electrochromic coating. Accordingly, this region is not subject to a change in optical properties and, as such, may not be able to be tinted in contrast to the region having a layer coated with the electrochromic coating.

As further illustrated in FIG. 1, an obscuration pattern 99, as described further herein, preferably may be formed on and along the interior surface 12 of the glass lite 10, although in alternative arrangements, it may be formed on and along other surfaces of the glass lite 10, such as but not limited to the inside surface 14. The obscuration pattern 99, as in the example of FIG. 1, preferably may be formed over a minimum distance to cover the portion of the region designated as having a distance x along at least a portion of the outer perimeter of the IGU 5. In some arrangements, the obscuration pattern 99 may extend a distance x+y, as further shown in FIG. 1, in which the distance y may correspond to a distance from the outer spacer seal 38 to the tip 22 of the outer frame seal 20, as in this example, or to an analogous obstruction at the exterior surface 11. Such a distance y represents a region that may also be visible to a person looking through an IGU, which is typically called the “clear edge” of the glass lites of an IGU. In other arrangements, the obscuration pattern 99 may extend a distance D+x in which no spacer is used. As shown, the obscuration pattern 99 may be formed around all or only a portion of the outer perimeter of the interior surface 12 so as to provide obscuration at all sides. In other arrangements, the obscuration pattern may be formed around only some of the sides or only a portion of some of the sides of the IGU.

In some such arrangements, the distance D+x preferably may be in the range between about 1 mm to about 30 mm, and more preferably in the range between about 5 mm to about 15 mm. In some such arrangements, the distance x preferably may overlap a projection of the electrochromic coating in a range between about 1 mm and about 10 mm, more preferably in a range between about 2 mm and about 5 mm, and most preferably in a range between about 2 mm and about 3 mm. In some such arrangements, the distance x+y preferably may be in the range between about 1 mm and about 20 mm and more preferably in the range between about 2 mm to 10 mm.

In some alternative arrangements, an obscuration pattern may be located along any of the exterior surface 11, the interior surface 12, and the inner surface 13. In some such arrangements, the obscuration pattern preferably may have a width that covers at least the distance x, as described previously herein with respect to the obscuration pattern 99. Moreover, in some such arrangements, the obscuration pattern preferably may have a width that covers a maximum of the distance x+y in instances in which a spacer is used, as further described previously herein with respect to the obscuration pattern 99, and a maximum of the distance D+x in instances in which a spacer is not used.

In some alternative arrangements, the obscuration pattern may be combined with other fixtures or coatings, such as but not limited to a reflective coating, which may be placed along the exterior surface 11, the interior surface 12, and optionally the inner surface 13, a solar control coating which may be placed along interior surface 12, or a photocatalytic coating, which may be deposited onto the exterior surface 11 or the inner surface 13. (See FIG. 1).

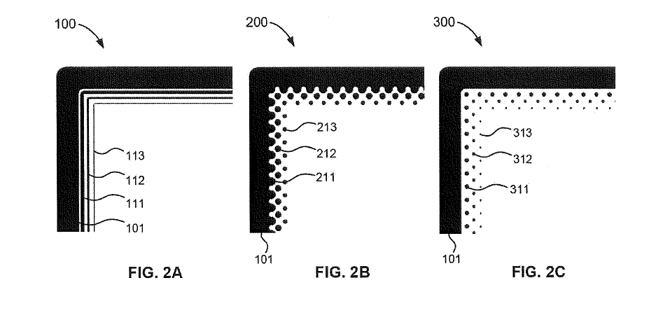

Referring now to FIGS. 2(A)-(C), an obscuration pattern in accordance with an embodiment may come in a variety of forms. As shown in FIG. 2(A), an obscuration pattern 100 may include a solid line 101. The solid line 101 may have a width that fully covers the portion of a visible region of an IGU over a distance x as described previously with respect to FIG. 1. As shown, the obscuration pattern 100 may include a series of lines 111-113 parallel to one another and to the solid line 101, although in some arrangements, the lines may be parallel in a direction perpendicular to the solid line 101, skew to one another or even cross-hatched, or may be in other repeating, aesthetically pleasing, patterns. As shown, the line 111 may be wider than the line 112 which may be wider than the line 113. However, in alternative arrangements, each of these lines may have the same width as at least one other of the lines. In some alternative arrangements, there may be a fewer or a greater number of lines in addition to the solid line 101.

As shown in FIG. 2(B), an obscuration pattern 200 may include a solid line 101. The line 101 may have a width that fully covers the portion of a visible region of an IGU over a distance x as described previously with respect to FIG. 1. As shown, the obscuration pattern 200 may include a series of dots along lines 211-213 parallel to one another, although in some arrangements, the dots may be parallel to one another in a direction perpendicular to the solid line 101 or may be in other repeating, aesthetically pleasing, patterns. As shown, the dots within the line of dots 211 may be wider than the dots within the line of dots 212 which may be wider than the dots within the line of dots 213. However, in alternative arrangements, the dots of any of these lines may have the same width as the dots of any other line of dots. In some alternative arrangements, there may be a fewer or a greater number of lines of dots in addition to the solid line 101.

As shown in FIG. 2(C), an obscuration pattern 300 may have a solid line 101 and parallel lines of dots 311-313 in a similar configuration to the lines of dots 211-213 of FIG. 2(B). However, in this example, the lines of dots 211-213 in FIG. 2(B) may all have a greater width than the counterpart lines of dots 311-313 shown in FIG. 2(C). As further shown in the examples of FIGS. 2(B) and 2(C), the lines of dots 211 may intersect with the solid line 101 whereas the lines of dots 311 may not intersect with the solid line 101. Such options may be design choices in which greater obscuration may be accomplished through the intersection of shapes of an obscuration pattern with the solid line but at a loss of some of the visible region through which a person may view the environment.

In some alternative arrangements, at least a portion of the obscuration pattern may formed of a variety of shapes, such as but not limited to lines of triangles, circles, or rectangles. In some alternative arrangements, such shapes may have holes in the middles thereof. In some alternative arrangements, such shapes may be evenly spaced apart within at least a portion of the obscuration pattern.

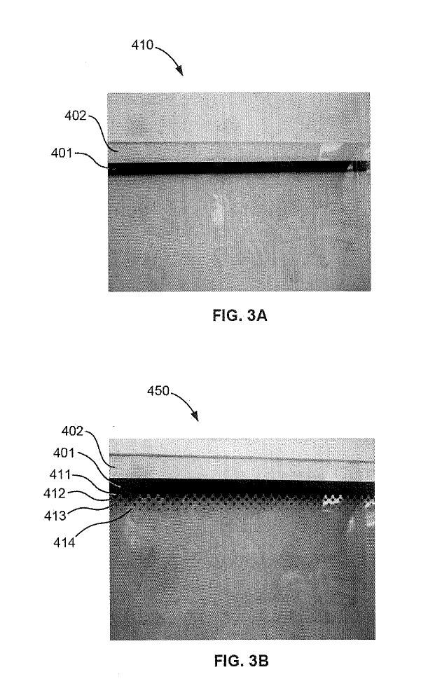

As illustrated in the examples of FIGS. 3(A) and (B), an obscuration pattern may be formed on different types of reflective coatings. As shown in FIG. 3(A), a solid line 401 may be formed on a glass lite 410 to define a clear edge 402 around an outer perimeter of the glass lite 410. As shown in FIG. 3(B), the solid line 401 may be formed on a glass lite 450 to define the clear edge 402. As shown, a series of lines of dots 411-414 may also be formed on the glass lite 450. Such lines of dots 411-414 may have a shape and configuration that are a combination of the lines of dots 211-213 and 311-313, as discussed with respect to FIGS. 2(A) and (B). As shown the example of FIG. 3(B), each of the solid line 401 and the lines of dots 411-414 may be formed with any reflective coating (e.g., Si₃N₄, low E coatings, and pyrolytic coatings).

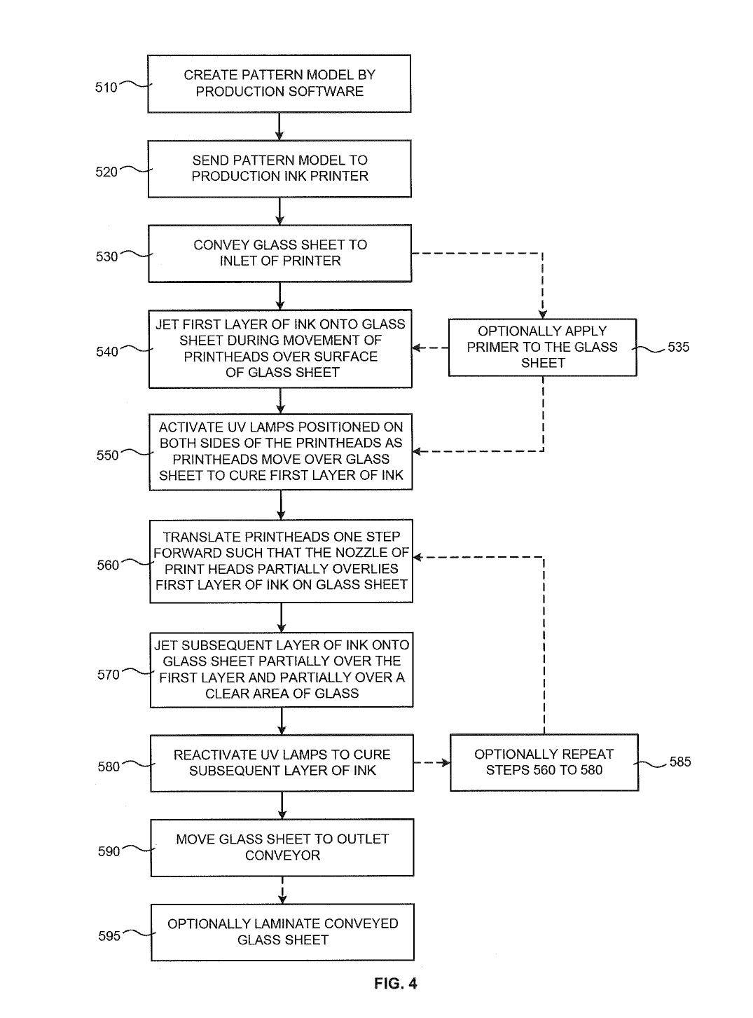

Referring now to the process flow diagram illustrated in FIG. 4, an obscuration pattern, such as those described previously herein, may be formed by a digital printing process 500. In this manner, it is believed that such a process provides a flexible way to automatically and accurately print patterns onto a substrate, such as a glass lite of an IGU. It is believed that such patterns may be of any color as well as of any shape when viewed in a plan view substantially perpendicular to the substrate and that the substrate may include any of convex and concave surfaces.

Such digital printing technology may be called a “drop on demand technology.” As shown in a step 510 of FIG. 4A, a pattern model may be created using production software, such as but not limited to MES from LISEC. In a step 520, the pattern model created may be sent to an ink printer, such as but not limited to a RS35 Polytype. In other arrangements, the printer may be a GlassJet printer from DIPTECH. In a step 530, a glass sheet, which may be a glass lite such as those described previously herein, or other substrate having any variety of known shapes and dimensions, may be conveyed to an inlet of the ink printer. In alternative arrangements, the glass sheet may be moved to the inlet of the printer through other processes known to those of ordinary skill in the art, such as by a manual movement of the sheet or through the use of a fork lift. In a step 540, a first layer of ink, which may be made of materials such as but not limited to reactive and unreactive acrylates (even those that may be UV cured) may be dispensed, which may be by a jetting, onto a surface of the glass sheet through printhead of the printer. The reactive acrylates preferably may be dark or pigmented to act as obscuration. Also, the inks may be silicon based inks. Using a piezoelectric membrane in the printhead to dispense the ink, the amount of ink jetted may be controlled to accurately dispense consistent amounts of ink. Moreover, using such printers, the print heads may be translated over the glass sheet and dispense ink drops in predetermined positions on the glass sheet only when needed. In this manner, the obscuration pattern may be deposited and formed onto the glass sheet. For example, the obscuration patterns 99, 100, 200, and 300, described previously herein, may all be formed in this manner.

In some arrangements, as shown in a step 535, to increase the adhesion of the ink to the glass sheet, a primer optionally may be applied onto a surface of the glass sheet. Such a primer may be applied by any number of processes such as vapor deposition, spray, pad printing, screen printing, or other methods known to those of ordinary skill in the art. In some arrangements, the primer optionally may be applied prior to step 540 in which the obscuration pattern may be printed. As further shown in step 535, the primer may be applied by a printer at the same time as the ink printing. In some instances, the primer may be dispensed by the same printer dispensing the ink.

In a step 550, ultraviolet (UV) lamps may be turned on and used to cure the first layer of ink after the ink has been deposited. The lamps preferably may be turned on in a range of approximately 15 seconds at the normal operating temperature of such lamps before the printing process starts. In some arrangements, such lamps may be located on both sides of the printheads of the printer such that the ink may be cured during the ink printing step 540 (as well as during the ink printing step 570 described further herein). In such a curing process, the ink may be cured at a rate of approximately 200 W/cm. In alternative arrangements, the ink may fired in an IR oven after some or preferably all ink printing steps, such as the steps 540 and 570. It should be noted that this curing step is, in some embodiments, not used to replace thermal heat treatment steps used to enhance thin film layers or a stack of thin film layers (as disclosed in U.S. Pat. No. 7,372,610, the disclosure of which is hereby incorporated by reference herein) or heat treatment steps used in the production of electrochromic device laminates (as disclosed in copending U.S. patent application Ser. Nos. 13/040,787 and 13/178,065, the disclosures of which are hereby incorporated by reference).

In a step 560, the printheads may be translated one step forward such that the one or more nozzles on the printheads partially overlies the first layer of ink on the glass sheet. The step that the printheads are translated may depend on one or both of the spacing to be applied between different layers of ink and a thickness desired for portions of the obscuration pattern.

In a step 570, a subsequent layer of ink may be dispensed, which may be by jetting such as described with respect to step 540. During such a step, the subsequent layer may be dispensed partially over the first layer and partially over an area of the glass in which no ink has been deposited, i.e., a clear area of the glass. In a step 580, the UV lamps may be reactivated to cure the subsequent layer of ink. In alternative arrangements, such subsequent layer of ink may be fired in an IR oven as described previously herein with respect to the first layer of ink.

In a step 585, each of steps 560 to 580 may be repeated to dispense and cure another subsequent layer of ink. During any of the ink printing steps 540, 570, and 585, the thickness of each layer of ink preferably may be in the range between 10 and 200 microns, and more preferably may be in the range between 40 and 100 microns.

In a step 590, following the deposition of all intended layers of ink, the glass sheet may be moved to an outlet conveyer which may move the glass sheet to a new location for further processing, such as to form an IGU. In alternative arrangements, the glass sheet may be moved by other well-known processes. As shown in a step 595, the glass sheet may be conveyed or otherwise moved to be laminated. When laminating the glass sheet, the thickness of the obscuration pattern may be monitored to avoid potential undesirable lamination issues. Accordingly, the thickness of the obscuration pattern preferably may have a thickness in the range of less than about 100 micrometers, and more preferably between about 1 to about 50 μm, to obtain the desired optical density to avoid stress and optical distortion of the laminate when printed on either of surfaces of a glass lite such as the interior surface 12 and the inner surface 13 of the glass lite 10.

1. An electrochromic device comprising:
a substrate;
an electrochromic coating overlying a portion of said substrate within a visible region of the substrate, said electrochromic coating having an outer edge spaced from an outer boundary of said visible region of the substrate, outer edge of said electrochromic coating and said outer boundary of said visible region defining a working region; and
at least one patterned layer deposited within said working region, said patterned layer including a plurality of spaced apart shapes.

2. The device of claim 1, the device being inserted within a frame, wherein said shapes run parallel to at least one of (i) said outer edge of the electrochromic coating, an inner edge of a seal between the device and the frame, and (iii) and an inner rim of the frame.

3. The device of claim 1, wherein said shapes are lines.

4. The device of claim 3, wherein said lines are parallel.

5. The device of claim 1, wherein said shapes are dots.

6. The device of claim 1, wherein said dots include at least a first plurality of dots arranged along a first line and a second plurality of dots arranged along a second line, and wherein said first plurality of dots are parallel to said second plurality of dots.

7. The device of claim 6, wherein each dot of said first plurality of dots has a first size and each dot of said second plurality of dots has a second size, wherein said first size is different than said second size.

8. The device of claim 7, wherein said dots further include at least a third plurality of dots arranged along a third line, the third plurality of dots being parallel to said first and second pluralities of dots,
wherein each dot of said first, second, and third pluralities of dots has first, second, and third radii, respectively,
wherein said second pluralities of dots are between said first and third pluralities of dots,
wherein said first radii of said first plurality of dots is greater than said second radii of the second plurality of dots, and
wherein said second radii of said second plurality of dots is greater than said third radii of said third plurality of dots.

9. The device of claim 1, wherein at least some of the shapes have at least one of different widths and different thicknesses.

10. The device of claim 1, the device being inserted within a frame, wherein said visible region is defined by one of an inner edge of a seal between the device and the frame and an inner rim of the frame.

11. The device of claim 1, wherein some of said spaced apart shapes have a different shape than other ones of said spaced apart shapes.

12. The device of claim 11, wherein said shapes include any of circles, triangles, and rectangles.

13. The device of claim 1, wherein the patterned layer has a thickness ranging from about 1 micrometer to about 50 micrometers.

14. The device of claim 1, wherein said substrate includes at least one of a reflective coating, a solar control coating, and a photocatalytic coating, and wherein said patterned layer is deposited onto the at least one coating.

15. The device of claim 1, wherein said substrate has four sides, and wherein said patterned layer is applied to one of (i) only one side, (ii) only two sides, (iii) only three sides, and (iv) all four sides of said substrate.

16. The device of claim 1, wherein at least a portion of said patterned layer is formed of a plurality of overlapping layers.

17. The device of claim 16, wherein at least one layer of said plurality of overlapping layers has a different color than another of said plurality of overlapping layers.

18. The device of claim 1, wherein at least one of said spaced apart shapes has a different color than other ones of said spaced apart shapes.

19. The device of claim 1, wherein said patterned layer is deposited onto said substrate such that it overlaps a projection onto said substrate of said outer edge of said electrochromic coating within said visible region.

20. An electrochromic device, the device being inserted within a frame, comprising:
a substrate;
an electrochromic coating covering a portion of said substrate within a visible region of the substrate, said visible region being defined by one of an inner edge of a seal and an inner rim of the frame, said electrochromic coating having an outer edge spaced from an outer boundary of said visible region of said substrate, said outer edge of the electrochromic coating and said outer boundary of said visible region defining a working region; and
at least one patterned layer deposited within said working region, said patterned layer including at least one of (i) a plurality of lines spaced apart from each other and (ii) a plurality of dots spaced from one another.

21. A substrate comprising:
a stack of thin films, said thin films having at least one edge; and
at least one patterned layer deposited on top of said thin film edge and running approximately the length of said edge, said patterned layer comprising at least one of (i) a series of lines and (ii) a series of dots.

22. The substrate of claim 21, wherein said stack includes at least one electrochromic material.

23. The substrate of claim 22, wherein said electrochromic material comprises a mixed tungsten-nickel oxide.

24. The substrate of claim 22, wherein said electrochromic material is a tungsten oxide.
